(19) United States
(12) Patent Application Publication
(10) Pub. No.: US 2019/0030659 A1
(43) Pub. Date: Jan. 31, 2019

(54) TURBINE WHEEL PROCESS IMPROVEMENT THAT REDUCES THE INCOMING IMBALANCE AND LOWERING THE IMPACT ON PERFORMANCE AND DURABILITY WHILE KEEPING THE SCRAP LOW

(71) Applicant: BorgWarner Inc., Auburn Hills, MI (US)

(72) Inventors: Lakshmi Srikar Yellapragada, Arden, NC (US); Gordon C. Jenks, Hendersonville, NC (US)

(21) Appl. No.: 15/663,046

(22) Filed: Jul. 28, 2017

(51) Int. Cl. B23P 15/00; B22C 9/04; F01D 5/34; F01D 5/04; B22C 7/02; F01D 5/02

(52) U.S. Cl. CPC B23P 15/006; B22C 9/04; F01D 5/34; F05D 2230/14; B22C 7/02; F01D 5/027; F05D 2230/21; F01D 5/048

(57) ABSTRACT

A number of variations may include a method that may include producing a turbine wheel may include; designing a turbine wheel may include a backwall opposite a nose; forming a wax-pattern of the turbine wheel; casting the turbine wheel; determining the center of gravity of the turbine wheel; identifying an axis of rotation of the turbine wheel; and machining the backwall of the turbine wheel.

### TECHNICAL FIELD

The field to which the disclosure generally relates includes methods of mass balancing turbine wheels during manufacturing.

### BACKGROUND

Manufacturing of turbine wheels often result in waviness issues in the backwall of the turbine. Waviness issues within a turbine may be a result of waviness in the wax pattern or instances where the blades of the turbine freeze before the hub of the wheel thereby causing a dip due to shrinkage of the metal during solidification where the blade meets the backwall of a turbine wheel.

### SUMMARY OF ILLUSTRATIVE VARIATIONS

A number of variations may include a method that may include: producing a turbine wheel; designing a turbine wheel which may include a backwall opposite a nose; forming a wax-pattern of the turbine wheel; casting the turbine wheel; determining the center of gravity of the turbine wheel; identifying an axis of rotation through the center of gravity of the turbine wheel; and machining the backwall of the turbine wheel.

A number of variations may include a method that may include: producing a turbine; designing a turbine wheel which may include a backwall, a hub portion, and a plurality of fins; forming a wax-pattern of the turbine wheel; casting the turbine wheel using the wax pattern; performing a mass balancing check on the turbine wheel to determine the center of gravity of the turbine wheel; identifying an axis of rotation of the turbine wheel; and machining the backwall of the turbine wheel; defining datum surfaces of the turbine wheel; assembling the turbine and a shaft to form a turbine assembly; joining the turbine wheel to a shaft; machining the turbine wheel and the shaft to form a shaft and turbine wheel assembly; performing a balance check on the shaft and turbine wheel assembly; and machining the shaft and turbine wheel assembly to further balance the shaft and turbine wheel assembly.

A number of variations may include a method that may include: producing a turbine; designing a turbine wheel which may include a backwall, a hub portion, a nose, and a plurality of fins; forming a wax-pattern of the turbine wheel; casting the turbine wheel; performing a mass balancing check on the turbine wheel to determine the center of gravity of the turbine wheel; identifying an axis of rotation of the turbine wheel which may include temporarily fixing the nose within at least one chuck and center-drilling the nose; and machining the backwall normal to the axis of rotation of the turbine wheel and wherein the backwall may further include a first portion centered within the backwall and a machined portion tangentially offset from the first portion by an draft angle ranging from about one degree to about ten degrees; defining datum surfaces of the turbine wheel; assembling the turbine and a shaft to form a turbine assembly; joining the turbine wheel to a shaft; machining the turbine wheel and the shaft to form a shaft and turbine wheel assembly; performing a balance check on the shaft and turbine wheel assembly; and machining the shaft and turbine wheel assembly to further balance the shaft and turbine wheel assembly.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts a flowchart of one variation of a method of forming a turbine wheel;

FIG. 2 depicts one cross-sectional view of one variation of a turbine wheel; and

FIG. 3 depicts one variation of a turbine wheel.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

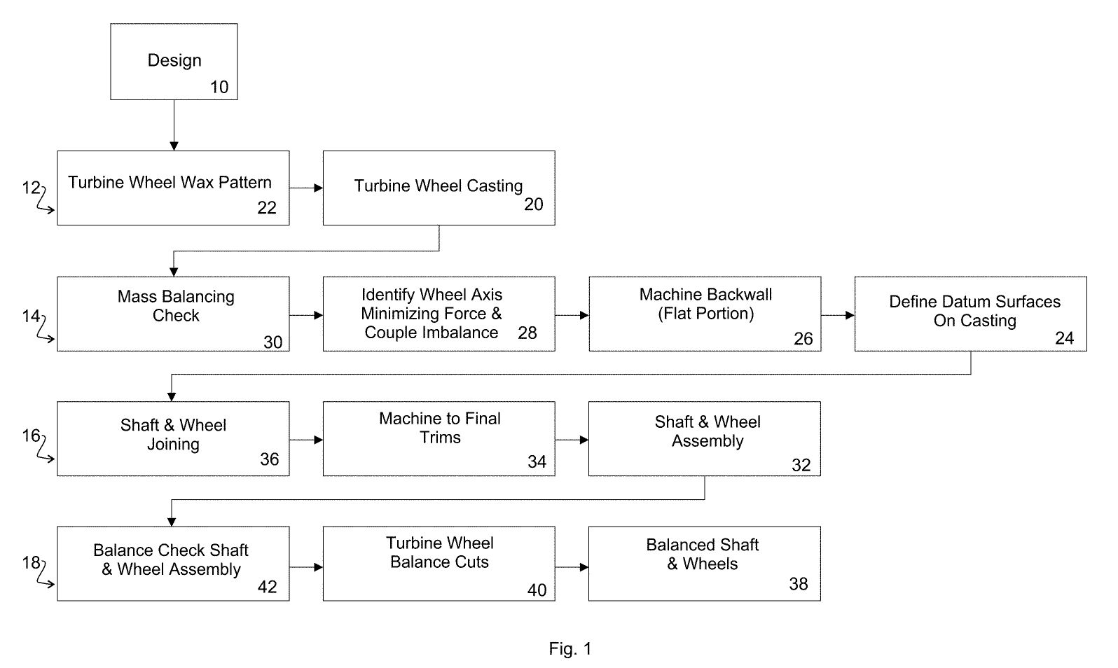

Referring to FIG. 1; a method of forming a turbine wheel may include designing 10 a turbine wheel comprising a first step 12 that may include forming a turbine wheel wax pattern 22, and casting a turbine wheel 20. The method may also include a second step 14 that may include performing a mass balancing check of the turbine wheel 30, identifying the wheel axis 28 including identifying mass imbalances and or couple imbalance in the turbine wheel and identifying the center of mass of the turbine wheel, machining the backwall 26, and defining datum surfaces on the turbine wheel 24. The datum surface may be a set of coordinates, reference surfaces, or reference points from which machining or mass balancing machinery may identify the turbine wheel 24 or wheel axis 28. A third step 16 may include joining the turbine wheel and a shaft 36, machining the turbine wheel to final trimmings 34, and assembling the shaft and the wheel 32 the form a shaft and wheel assembly. A fourth step 18 may include performing a mass balance check on the shaft and wheel assembly 42, performing wheel balance cuts 40 to produce a balanced shaft and wheel assembly 38.

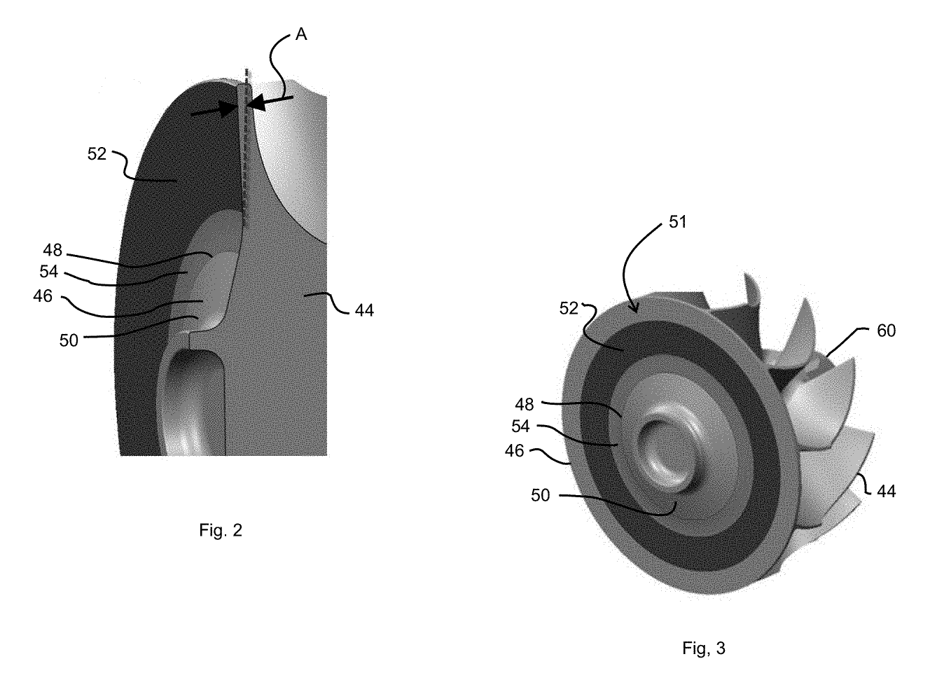

Referring to FIGS. 2 and 3; a cast turbine wheel 44 may include a backwall 46 such as a fullback or superback which may be a turbine wheel having a backwall having a generally cone shaped reinforced region transitioning to a flat portion, wherein the backwall 46 may include a first portion 50, and as-cast portion 52, a machined portion 51 and a transition portion 54 between the first portion 50 and the machined portion 51. The machined portion 51 may be tangentially offset from the first portion 50 by a draft angle A that may range from about one degree to about ten degrees. The draft angle A may range from about two degrees to about five degrees. A juncture 48 may be located between the cast portion 50 and the transition portion 54 or between the transition portion 54 and the machined portion 51 or both and may be a smooth juncture between adjacent portions 50, 52, and 54.

Referring to FIGS. 1-3; the second step 14 may include performing a mass balancing check 30 on a turbine wheel including a backwall 46 and a nose 60 opposite the backwall wherein the nose may be held in position by a chuck or center-drilling the nose to define an axis of rotation of the turbine wheel. The wheel axis may be identified 28 in this way to find an axis of rotation closer to the center of gravity as determined by a mass balancer via the geometry of the turbine wheel or the center of gravity or both. As an example, defining an axis of rotation via creating an axis of rotation normal to the plane of the flat backwall may result in an axis of rotation that is off from the center of gravity, even if perpendicularity of the axis of rotation to the flat backwall is maintained. After the wheel axis has been identified 28, the backwall may be subsequently machined 26 perpendicular to that of the axis of rotation. Datum surfaces on the machined turbine wall may be subsequently defined on the casting 24 prior to step three 16.

According to variation 1, a method may include: producing a turbine wheel; designing a turbine wheel which may include a backwall opposite a nose; forming a wax-pattern of the turbine wheel; casting the turbine wheel; determining the center of gravity of the turbine wheel; identifying an axis of rotation of the turbine wheel; and machining the backwall of the turbine wheel.

Variation 2 may include a product as set forth in variation 1 wherein determining the center of gravity of the turbine wheel may include performing a mass balance check on the turbine wheel.

Variation 3 may include a product as set forth in variation 1 or 2 wherein machining the backwall of the turbine wheel may include machining the backwall normal to the axis of rotation of the turbine wheel.

Variation 4 may include a product as set forth in any of variations 1 through 3 wherein machining the backwall of the turbine wheel may include machining the backwall normal to the axis of rotation of the turbine wheel and wherein the backwall may further include a first portion centered within the backwall and an outer machined portion offset from the first portion by a draft angle ranging from about one degree to about ten degrees.

Variation 5 may include a product as set forth in any of variations 1 through 4. The method as set forth in claim 1 wherein machining the backwall of the turbine wheel may include machining the backwall normal to the axis of rotation of the turbine wheel and wherein the backwall may further include a first portion centered within the backwall and a machined portion offset from the first portion by a draft angle ranging from about two degrees to about five degrees.

Variation 6 may include a product as set forth in any of variations 1 through 5 and may further include: assembling the turbine and a shaft to form a turbine assembly; joining the turbine wheel to a shaft; and machining the turbine wheel and the shaft to form a shaft and turbine wheel assembly.

Variation 7 may include a product as set forth in any of variations 1 through 6 and may further include: performing a balance check on the shaft and turbine wheel assembly; and machining the shaft and turbine wheel assembly to further balance the shaft and turbine wheel assembly.

Variation 8 may include a product as set forth in any of variations 1 through 7 wherein determining the center of gravity of the turbine wheel may include performing a mass balancing check on the turbine wheel.

Variation 9 may include a product as set forth in any of variations 1 through 8 wherein machining the backwall of the turbine wheel may include machining the backwall to define a rear face normal to the axis of rotation of the turbine wheel.

According to a tenth variation, a method may include: producing a turbine may include; designing a turbine wheel may include a backwall, a hub portion, and a plurality of fins; forming a wax-pattern of the turbine wheel; casting the turbine wheel; performing a mass balancing check on the turbine wheel to determine the center of gravity of the turbine wheel; identifying an axis of rotation of the turbine wheel; and machining the backwall of the turbine wheel; defining datum surfaces, reference points, or references surfaces on the turbine wheel; assembling the turbine and a shaft to form a turbine assembly; joining the turbine wheel to a shaft; machining the turbine wheel and the shaft to form a shaft and turbine wheel assembly; performing a balance check on the shaft and turbine wheel assembly; and machining the shaft and turbine wheel assembly to further balance the shaft and turbine wheel assembly.

Variation 11 may include a product as set forth in variation 10 wherein determining the center of gravity of the turbine wheel may include performing a mass balance check on the turbine wheel.

Variation 12 may include a product as set forth in any of variations 10 through 11 wherein machining the backwall of the turbine wheel may include machining the backwall normal to the axis of rotation of the turbine wheel.

Variation 13 may include a product as set forth in any of variations 10 through 12 wherein machining the backwall of the turbine wheel may include machining the backwall normal to the axis of rotation of the turbine wheel and wherein the backwall may further include a first portion centered within the backwall and which may be normal to the axis of rotation and an outer machined portion tangentially offset from the first portion by a draft angle ranging from about one degree to about ten degrees.

Variation 14 may include a product as set forth in any of variations 10 through 13 wherein machining the backwall of the turbine wheel may include machining the backwall normal to the axis of rotation of the turbine wheel and wherein the backwall may further include a first portion centered within the backwall and a machined portion tangentially offset from the first portion by a draft angle ranging from about two degrees to about five degrees.

Variation 15 may include a product as set forth in any of variations 10 through 14 wherein the machining of the shaft and turbine wheel assembly to further balance the shaft and turbine wheel assembly may include machining the backwall to define a rear face normal to the axis of rotation of the turbine wheel.

Variation 16 may include a product as set forth in any of variations 10 through 15 wherein the backwall may include a superback.

According to a seventeenth variation, a method may include: producing a turbine may include; designing a turbine wheel may include a backwall, a hub portion, a nose, and a plurality of fins; forming a wax-pattern of the turbine wheel; casting the turbine wheel; performing a mass balancing check on the turbine wheel to determine the center of gravity of the turbine wheel; identifying an axis of rotation of the turbine wheel may include temporarily fixing the nose within at least one chuck and center-drilling the nose; and machining the backwall normal to the axis of rotation of the turbine wheel and wherein the backwall may further include a first portion centered within the backwall and a machined portion tangentially offset from the first portion by an draft angle ranging from about one degree to about ten degrees; defining datum surfaces of the turbine wheel; assembling the turbine and a shaft to form a turbine assembly; joining the turbine wheel to a shaft; machining the turbine wheel and the shaft to form a shaft and turbine wheel assembly; performing a balance check on the shaft and turbine wheel assembly; and machining the shaft and turbine wheel assembly to further balance the shaft and turbine wheel assembly.

Variation 18 may include a product as set forth in variation 17 wherein the machining of the shaft and turbine wheel assembly to further balance the shaft and turbine wheel assembly may include machining the backwall to define a rear face normal to the axis of rotation of the turbine wheel

Variation 19 may include a product as set forth in any of variations 17 through 18 wherein the backwall may further include a first portion centered within the backwall and a machined portion tangentially offset from the first portion by a draft angle ranging from about two degrees to about five degrees.

Variation 20 may include a product as set forth in any of variations 17 through 19 wherein the backwall may include a superback.

The above description of variations of the invention is merely demonstrative in nature and, thus, variations thereof are not to be regarded as a departure from the spirit and scope of the inventions disclosed within this document.

What is claimed is:

1. A method comprising:
producing a turbine wheel comprising;
designing a turbine wheel comprising a backwall opposite a nose;
forming a wax-pattern of the turbine wheel;
casting the turbine wheel;
determining the center of gravity of the turbine wheel;
identifying an axis of rotation of the turbine wheel corresponding to the center of gravity; and
machining the backwall of the turbine wheel.

2. The method as set forth in claim 1 wherein determining the center of gravity of the turbine wheel comprises performing a mass balance check on the turbine wheel.

3. The method as set forth in claim 1 wherein machining the backwall of the turbine wheel comprises machining the backwall normal to the axis of rotation of the turbine wheel.

4. The method as set forth in claim 1 wherein machining the backwall of the turbine wheel comprises machining the backwall normal to the axis of rotation of the turbine wheel and wherein the backwall further comprises a first portion centered within the backwall and an outer machined portion offset from the first portion by a draft angle ranging from about one degree to about ten degrees.

5. The method as set forth in claim 1 wherein machining the backwall of the turbine wheel comprises machining the backwall normal to the axis of rotation of the turbine wheel and wherein the backwall further comprises a first portion centered within the backwall and a machined portion offset from the first portion by a draft angle ranging from about two degrees to about five degrees.

6. The method as set forth in claim 1; further comprising:
assembling the turbine and a shaft to form a turbine assembly;
joining the turbine wheel to a shaft; and
machining the turbine wheel and the shaft to form a shaft and turbine wheel assembly.

7. The method as set forth in claim 6; further comprising:
performing a balance check on the shaft and turbine wheel assembly; and
machining the shaft and turbine wheel assembly to further balance the shaft and turbine wheel assembly.

8. The method as set forth in claim 1 wherein determining the center of gravity of the turbine wheel comprises performing a mass balancing check on the turbine wheel.

9. The method as set forth in claim 1 wherein machining the backwall of the turbine wheel comprises machining the backwall to define a rear face normal to the axis of rotation of the turbine wheel.

10. A method comprising:
producing a turbine comprising;
designing a turbine wheel comprising a backwall, a hub portion, and a plurality of fins;
forming a wax-pattern of the turbine wheel;
casting the turbine wheel;
performing a mass balancing check on the turbine wheel to determine the center of gravity of the turbine wheel;
identifying an axis of rotation of the turbine wheel; and
machining the backwall of the turbine wheel;
defining datum surfaces of the turbine wheel;
assembling the turbine and a shaft to form a turbine assembly;
joining the turbine wheel to a shaft;
machining the turbine wheel and the shaft to form a shaft and turbine wheel assembly;
performing a balance check on the shaft and turbine wheel assembly; and
machining the shaft and turbine wheel assembly to further balance the shaft and turbine wheel assembly.

11. The method as set forth in claim 10 wherein determining the center of gravity of the turbine wheel comprises performing a mass balance check on the turbine wheel.

12. The method as set forth in claim 10 wherein machining the backwall of the turbine wheel comprises machining the backwall normal to the axis of rotation of the turbine wheel.

13. The method as set forth in claim 10 wherein machining the backwall of the turbine wheel comprises machining the backwall normal to the axis of rotation of the turbine wheel and wherein the backwall further comprises a first portion centered within the backwall and which is normal to the axis of rotation and an outer machined portion tangentially offset from the first portion by a draft angle ranging from about one degree to about ten degrees.

14. The method as set forth in claim 10 wherein machining the backwall of the turbine wheel comprises machining the backwall normal to the axis of rotation of the turbine wheel and wherein the backwall further comprises a first portion centered within the backwall and a machined portion tangentially offset from the first portion by a draft angle ranging from about two degrees to about five degrees.

15. The method as set forth in claim 10 wherein the machining of the shaft and turbine wheel assembly to further balance the shaft and turbine wheel assembly comprises machining the backwall to define a rear face normal to the axis of rotation of the turbine wheel.

16. A method comprising:
producing a turbine comprising;
designing a turbine wheel comprising a backwall, a hub portion, a nose, and a plurality of fins;
forming a wax-pattern of the turbine wheel;
casting the turbine wheel;
performing a mass balancing check on the turbine wheel to determine the center of gravity of the turbine wheel;
identifying an axis of rotation of the turbine wheel comprising temporarily fixing the nose within at least one chuck and center-drilling the nose; and
machining the backwall normal to the axis of rotation of the turbine wheel and wherein the backwall further comprises a first portion centered within the backwall and a machined portion tangentially offset from the first portion by a draft angle ranging from about one degree to about ten degrees;
defining datum surfaces of the turbine wheel;
assembling the turbine and a shaft to form a turbine assembly;
joining the turbine wheel to a shaft;
machining the turbine wheel and the shaft to form a shaft and turbine wheel assembly;
performing a balance check on the shaft and turbine wheel assembly; and
machining the shaft and turbine wheel assembly to further balance the shaft and turbine wheel assembly.

17. The method as set forth in claim 16 wherein the machining of the shaft and turbine wheel assembly to further balance the shaft and turbine wheel assembly comprises machining the backwall to define a rear face normal to the axis of rotation of the turbine wheel.

18. The method as set forth in claim 16 wherein the backwall further comprises a first portion centered within the backwall and a machined portion tangentially offset from the first portion by a draft angle ranging from about two degrees to about five degrees.
